(19) United States
(12) Patent Application Publication
(10) Pub. No.: US 2022/0081228 A1
(43) Pub. Date: Mar. 17, 2022

(54) VEHICLE-MOUNTED BULK MATERIAL TENDER

(71) Applicant: Productive Resources, LLC, Springfield, IL (US)

(72) Inventor: Dathan Johnson, Springfield, IL (US)

(21) Appl. No.: 17/475,138

(22) Filed: Sep. 14, 2021

Related U.S. Application Data
(60) Provisional application No. 63/078,633, filed on Sep. 15, 2020.

(51) Int. Cl. B65G 53/08; B66F 7/10; B65G 47/19; B65G 41/00

(52) U.S. Cl. CPC B65G 53/08; B66F 7/10; A01C 7/20; B65G 41/003; B65G 2814/0344; B65G 47/19

(57) ABSTRACT

A bulk material tender is described. The bulk material tender includes a hopper. The hopper includes one or more side walls defining a top opening and a bottom opening. The bulk material may also include a frame connected to and supporting the hopper. The bulk material tender may also include a rotary airlock for receiving material from the hopper. The bulk material tender may also include a pneumatic conveyor coupled to the rotary airlock for conveying the material to a desired location. The bulk material tender may also include a slide gate valve between the rotary airlock and the hopper. The bulk material tender may also include support legs and jacks for self-loading and self-unloading from a vehicle.

### CROSS-REFERENCE TO RELATED APPLICATION

The present application claims the benefit of U.S. Provisional Application Ser. No. 63/078,633, filed on Sep. 15, 2020, titled VEHICLE MOUNTED BULK MATERIAL TENDER, naming Dathan Johnson as inventor, which is incorporated herein by reference in the entirety.

### TECHNICAL FIELD

The present disclosure generally relates to bulk storage containers, and more particularly to bulk storage containers transportable by vehicle.

### BACKGROUND

Seed tenders are used for transporting bulk seed to be planted. The seed tender can bulk fill a planter through a central fill container or can fill individual seed boxes. Seed tenders come in a variety of configurations, including integrated bulk seed hoppers or configurations that accept seed boxes, such as a Pro-Box. Seed tenders are typically used with augers for ease of conveying. Seed tenders are commonly attached to a trailer, with the trailer being hooked to a pickup truck by a trailer hitch or a fifth-wheel hitch. Such trailers may require additional maintenance and licensing. Furthermore, the trailers may take up a large amount of storage space and when operating, can be hard to maneuver in fields with difficult access. Therefore, it would be advantageous to provide a device that can provide seed tender functionality without the need for a separate trailer.

### SUMMARY

A bulk material tender is described, in accordance with one or more illustrative embodiments of the present disclosure. In one illustrative embodiment, the bulk material tender includes a hopper including one or more side walls. In another illustrative embodiment, the one or more side walls define a top opening of the hopper by which the hopper is configured to receive material. In another illustrative embodiment, the one or more side walls of the hopper further define a bottom opening of the hopper. In another embodiment, the bottom opening is configured to receive the material from the hopper by a gravity feed. In another illustrative embodiment, the bulk material tender includes a frame connected to the hopper. In another illustrative embodiment, the frame is configured to support the hopper by the connection between the frame and the hopper. In another illustrative embodiment, the frame includes an outer perimeter with a width of less than forty-eight inches by which the frame is adapted to fit between wheel wells of a pickup truck. In another illustrative embodiment, the bulk material tender includes a rotary airlock configured to receive material from the hopper. In another illustrative embodiment, the bulk material tender includes a pneumatic conveyor coupled to the rotary airlock. In another illustrative embodiment, the pneumatic conveyor includes a hose. In another illustrative embodiment, the pneumatic conveyor is configured to generate a pressure to convey the material by way of the hose. In another illustrative embodiment, the bulk material tender includes a power unit configured to supply power to at least the pneumatic conveyor. In another illustrative embodiment, the pneumatic conveyor is configured to generate the pressure in response to the power supplied from the power unit.

A material tending system is described, in accordance with one or more embodiments of the present disclosure. In one illustrative embodiment, the material tending system includes a pickup truck. In another illustrative embodiment, the material tending system includes a bulk material tender. In another illustrative embodiment, the bulk material tender includes a hopper including one or more side walls. In another illustrative embodiment, the one or more side walls define a top opening of the hopper by which the hopper is configured to receive material. In another illustrative embodiment, the one or more side walls of the hopper further define a bottom opening of the hopper. In another embodiment, the bottom opening is configured to receive the material from the hopper by a gravity feed. In another illustrative embodiment, the bulk material tender includes a frame connected to the hopper. In another illustrative embodiment, the frame is configured to support the hopper by the connection between the frame and the hopper. In another illustrative embodiment, the frame includes an outer perimeter with a width of less than forty-eight inches by which the frame is adapted to fit between wheel wells of a pickup truck. In another illustrative embodiment, the bulk material tender includes a rotary airlock configured to receive material from the hopper. In another illustrative embodiment, the bulk material tender includes a pneumatic conveyor coupled to the rotary airlock. In another illustrative embodiment, the pneumatic conveyor includes a hose. In another illustrative embodiment, the pneumatic conveyor is configured to generate a pressure to convey the material by way of the hose. In another illustrative embodiment, the bulk material tender includes a power unit configured to supply power to at least the pneumatic conveyor. In another illustrative embodiment, the pneumatic conveyor is configured to generate the pressure in response to the power supplied from the power unit.

A bulk material tender is described, in accordance with one or more illustrative embodiments of the present disclosure. In one illustrative embodiment, the bulk material tender includes a hopper including one or more side walls. In another illustrative embodiment, the one or more side walls define a top opening of the hopper by which the hopper is configured to receive material. In another illustrative embodiment, the one or more side walls of the hopper further define a bottom opening of the hopper. In another illustrative embodiment, the bottom opening is configured to receive the material from the hopper by a gravity feed. In another illustrative embodiment, the bulk material handler includes a frame connected to the hopper. In another illustrative embodiment, the frame is configured to support the hopper by the connection between the frame and the hopper. In another illustrative embodiment, the frame includes upper-cross members, leg members, and lower-cross members. In another illustrative embodiment, the frame includes an outer perimeter defined by the leg members and the lower-cross members. In another illustrative embodiment, the outer perimeter includes a width of less than forty-eight inches. In another illustrative embodiment, the bulk material handler includes a plurality of support legs coupled to the upper-cross members of the frame. In another illustrative embodiment, the bulk material handler includes a plurality of plurality of jacks coupled to the plurality of support legs. In another illustrative embodiment, the plurality of jacks are vertically adjustable by which the jacks are configured to translate the plurality of support legs, the frame, and the hopper. In another illustrative embodiment, the bulk material handler includes a slide gate valve coupled to the bottom opening of the hopper. In another illustrative embodiment, the bulk material handler includes a rotary airlock coupled to the slide gate valve by which the rotary airlock is configured to receive material from the hopper. In another illustrative embodiment, the bulk material handler includes a pneumatic conveyor coupled to the rotary airlock. In another illustrative embodiment, the pneumatic conveyor includes a hose. In another illustrative embodiment, the pneumatic conveyor is configured to generate a pressure to convey the material by way of the hose. In another illustrative embodiment, the bulk material handler includes a power unit configured to supply power to at least the pneumatic conveyor. In another illustrative embodiment, the pneumatic conveyor is configured to generate the pressure in response to the power supplied from the power unit.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1A illustrates a perspective view of a bulk material tender with a sliding rail in a stowed position, in accordance with one or more embodiments of the present disclosure;

FIG. 1B illustrates a perspective view of a bulk material tender with a sliding rail in a deployed position, in accordance with one or more embodiments of the present disclosure;

FIG. 1C illustrates a front view of a bulk material tender, in accordance with one or more embodiments of the present disclosure

FIG. 1D illustrates a perspective view of a bulk material tender with a sliding rail in a deployed position, in accordance with one or more embodiments of the present disclosure;

FIG. 1E illustrates a lower perspective view of a bulk material tender with a sliding rail in a deployed position and with a rotary airlock including no hose connected, in accordance with one or more embodiments of the present disclosure;

FIG. 1F illustrates a top view of a bulk material tender with a sliding rail in a deployed position, in accordance with one or more embodiments of the present disclosure;

FIG. 2 illustrates a simplified control diagram of a bulk material tender, in accordance with one or more embodiments of the present disclosure;

FIG. 3A illustrates a perspective view of the bulk material tender resting on a pickup truck with a sliding rail in a stowed position, in accordance with one or more embodiments of the present disclosure; and

FIG. 3B illustrates a perspective view of the bulk material tender resting on the pickup truck with a sliding rail in a deployed position, in accordance with one or more embodiments of the present disclosure.

### DETAILED DESCRIPTION OF THE INVENTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

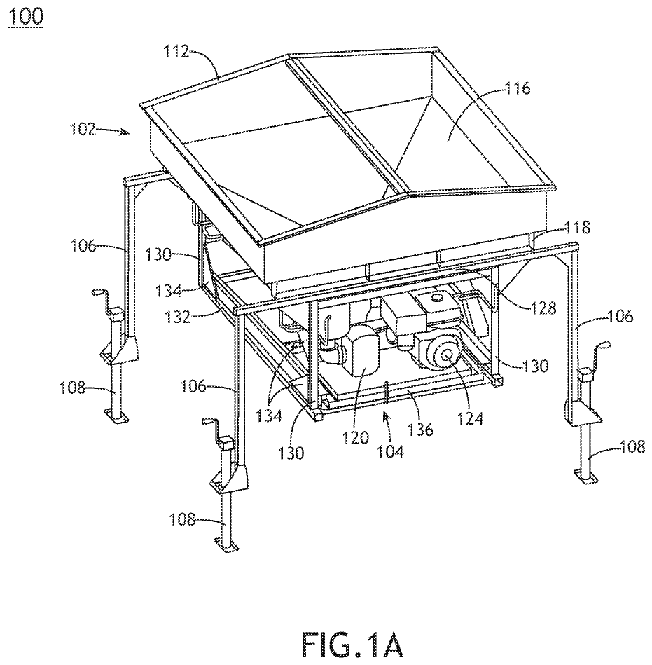

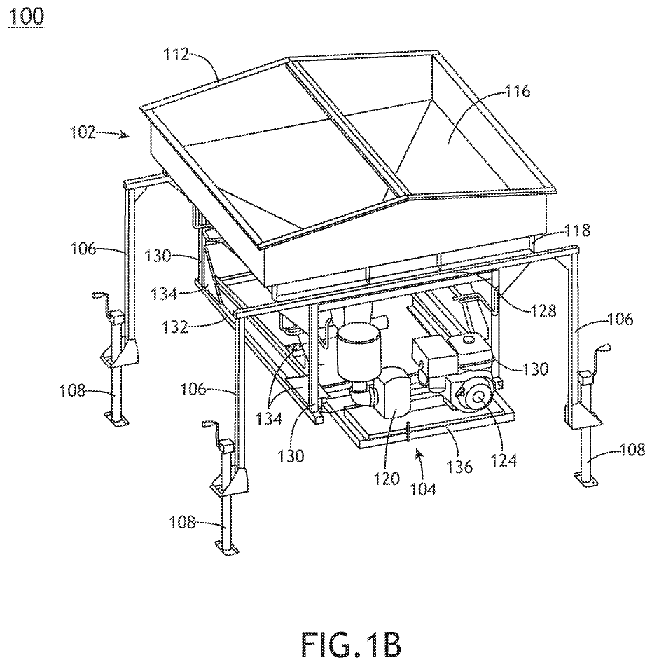

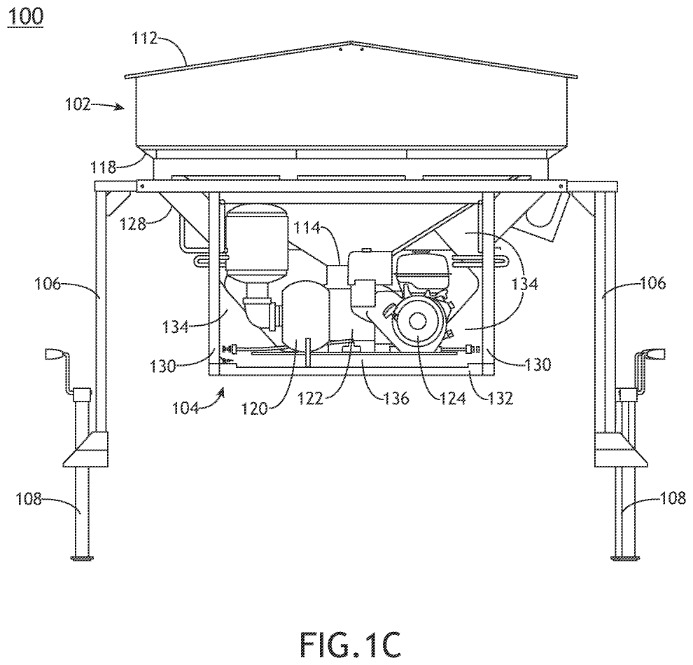

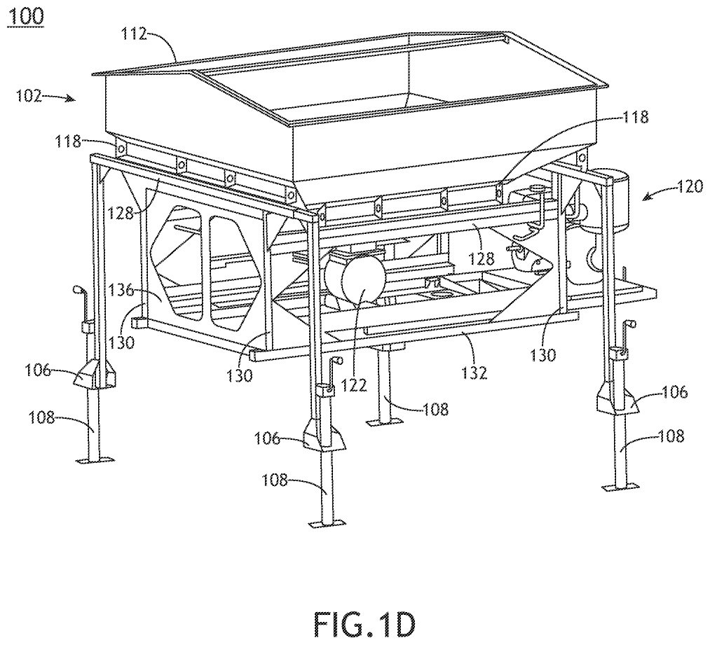

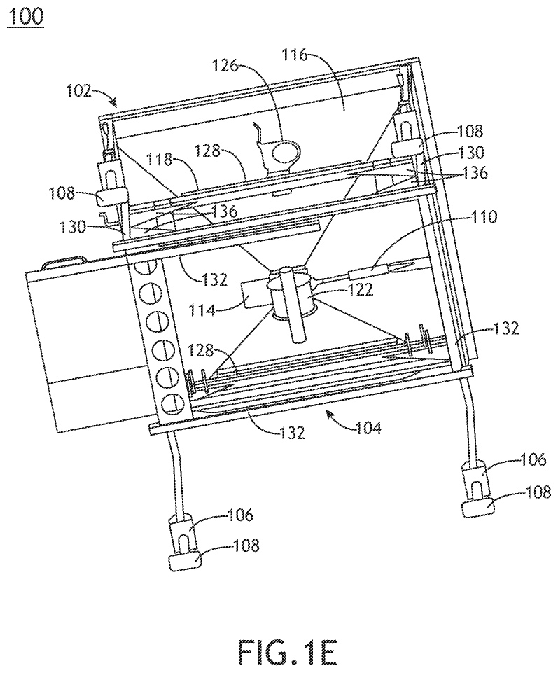

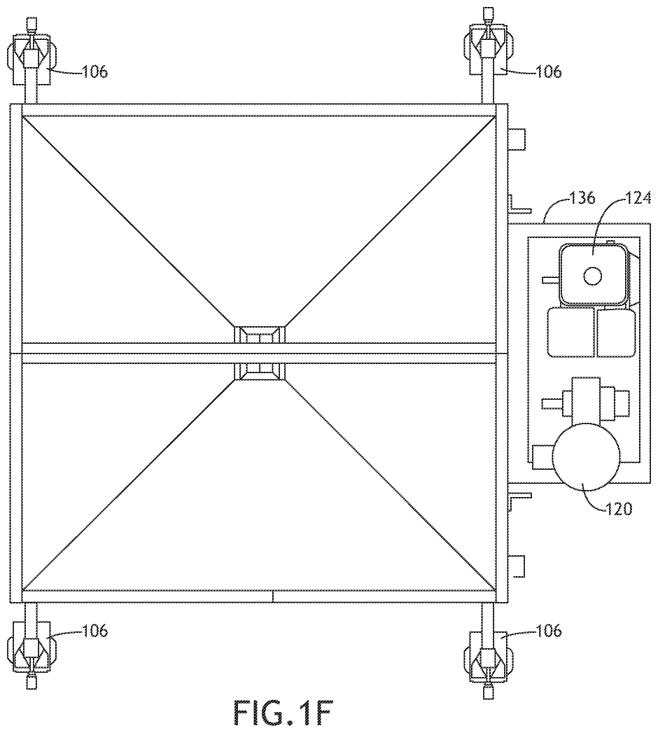

Referring generally to FIGS. 1A-3, a bulk material tender 100 and a material tending system 300 are disclosed, in accordance with one or more embodiments of the present disclosure. Embodiments of the present disclosure are directed to a bulk material tender 100. The bulk material tender 100 may dispense bulk material and further may provide for ease of hauling by a trailer or a truck bed. The bulk material tender 100 may include a hopper for receiving the bulk material. The hopper may be supported by a frame, with the frame being able to fit onto a truck bed. The bulk material may be selectively dispensed from a bottom opening of the hopper by a slide gate valve. A rotary airlock may be coupled to the slide gate valve for receiving the material from the hopper. A pneumatic conveyor may further be coupled to the rotary airlock for conveying the material to a desired location. The bulk material tender 100 may include one or more support legs and one or more jacks by which the bulk material tender 100 may be raised from and lowered onto a truck bed. The one or more support legs or the one or more jacks may be detachably attached to the frame, which reduces a size of the bulk material tender when transporting the bulk material tender by truck. The frame may include a slide assembly for further reducing the size of the bulk material tender. By the reduced size due to the slide assembly, the frame may fit onto the truck bed with a lift gate of the truck bed closed. A material tending system 300 is further described. The material tending system 300 may include the bulk material tender 100 and the pickup truck.

Referring now to FIGS. 1A-1E, the bulk material tender 100 is described, in accordance with one or more embodiments of the present disclosure. In embodiments, the bulk material tender 100 may include one or more of a hopper 102, a frame 104 connected to the hopper 102, one or more support legs 106 connected to the frame 104, and one or more jacks 108, a slide gate valve 110, a pneumatic conveyor 120, a rotary airlock 122, a power unit 124, or a slide assembly 136.

The bulk material tender 100 may include the hopper 102. The hopper 102 may include one or more side walls 116. The side walls 116 may include any material, including, but not limited to, plastic, metal, or composite materials. For example, the side walls 116 may include a molded plastic material such as, but not limited to, acrylonitrile-butadiene-styrene (ABS), acrylics, polyethylene (PE), polypropylene (PP), or polyvinyl chloride (PVC). By way of another example, the hopper 102 may comprise material such as, but not limited to, aluminum, steel, or stainless steel.

The side walls 116 may define a top opening 112. By the top opening 112, the hopper may be configured to receive material. The hopper 102 may be configured to receive bulk material. The bulk material received may include any bulk material, such as, but not limited to, seed. In some embodiments, the bulk material tender 100 is configured to receive bulk material from a seed box by the top opening 112 of the hopper 102. Seed boxes are common transportation units for bulk seed material. The seed boxes may include a given base size (e.g., a base of 57″ by 45″ with a variable height; etc.). The seed boxes may include a given volume of seed (e.g., between 50 cubic feet and 75 cubic feet). The seed boxes may output seed to the hopper 102. Components of the bulk material tender 100, such as the frame 104 or the hopper 102, may be configured to receive and secure the seed box while the seed is being received. For example, the hopper 102 may include a volume of between 50 cubic feet and 75 cubic feet.

The side walls 116 may further define a bottom opening 114. The material disposed within the hopper may be provided to the bottom opening 114 by a gravity feed. In this regard, the side walls 116 may taper from the top opening 112 to the bottom opening 114. Gravity may then pull material held within the side walls 116 down towards the bottom opening 114. The taper of the side walls 116 may provide a normal force to the materials, thereby pushing the materials inwards toward the center of the hopper 102. The hopper 102 may be designed with several considerations, including, but not limited to, capacity and material flow rate. In this regard, the capacity of the hopper 102 may be balanced with achieving appropriate flow rates. Such flow rate considerations may further be evaluated based on a size of the bottom opening 114 and the type of powered actuator used to discharge material from the hopper 102. As illustrated by the various depictions of hopper 102, the side walls 116 may include an angled pitch between the bottom opening 114 and the top opening 112. In this regard, material held by the hopper 102 is funneled into the bottom opening 114 by a gravity feed. Furthermore, the hopper 102 may include any suitable design, including, but not limited to, conical or wedge-shaped hoppers. The hopper 102 described and further depicted in the various figures is not intended as a limitation on the scope of the present disclosure. Thus, the dimensions of the hopper 102, including the top opening 112, bottom opening 114, and the taper of the side walls 116, may be selected based upon the material to be conveyed. Furthermore, the side walls 116 may be selectively dimensioned for being received by the frame 104.

The hopper 102 may also include one or more mounting brackets 118. The mounting brackets 118 may be spaced apart along one or more sides of the side wall 116. As depicted, each side of the hopper 102 may include the mounting brackets 118. Although this is not intended to be limiting. The mounting brackets 118 may be formed on the side walls 116 of the hopper 102 or may be connected to the side walls 116 of the hopper 102 (e.g., by one or more of a weld or a bolt).

In some embodiments, the hopper 102 includes one or more weather shield connectors (not depicted). The weather shield connectors may be configured to receive and secure a weather shield. The weather shield may cover the top opening 112. By covering the top opening, the weather shield may shield the bulk material contained within the hopper 102 from weather, such as rain and snow. In this regard, the weather shield may form a watertight connection with the top opening 112.

The bulk material tender 100 may also include the frame 104. The frame 104 may be connected to the hopper 102. The frame 104 may include one or more upper-cross members 128. The upper-cross members 128 may be arranged to receive and couple with the hopper 102 (e.g., by the mounting brackets 118). In this regard, the frame 104 may be connected to the hopper 102. By the connection with the hopper 102, the frame 104 may constrain the movement of the hopper 102. The frame 104 may also include one or more leg members 130. The leg members 130 may be coupled to one or more of the upper-cross members 128. The leg members 130 may be generally oriented in a substantially vertical direction when the frame 104 is supported on a surface. The frame 104 may also include one or more lower-cross members 132. The lower cross-members 132 may be coupled to one or more of the leg members 130. In this regard, a weight borne by the upper-cross members 128 may be transferred to the lower-cross members 132 by the leg members 130. The lower-cross members 132 may then transfer the weight into a surface (e.g., a truck bed or a ground surface). The frame 104 may thus hold a load of the bulk material tender 100 when the bulk material tender 100 rests on the surface. As may be understood, the leg members 130 may be coupled to the upper-cross members 128 and the lower cross members 132 in any suitable fashion (e.g., one or more of a weld or a bolt).

Standard width truck beds may accommodate widths of up to 48 inches between wheel wells. Compact width truck beds may accommodate widths of up to 42 inches. In some embodiments, the frame 104 may be designed to fit within a width of a truck bed. In this regard, the frame 104 may include an outer perimeter (e.g., a base). The outer perimeter may be defined by the leg members 130 and the lower-cross members 132. A width of the perimeter may be selected such that the frame 104 may be adapted to fit within a stowage area of the vehicle (e.g., between one or more of the inner side walls or the wheel wells of the truck). For example, the width of the perimeter may be 48 inches, 42 inches, or less. Thus, the width of the outer perimeter is selected such that the frame 104 is adapted to between the wheel wells without regard to the wheel well placement. In this regard, the frame 104 may fit within a variety of pickup truck models. Furthermore, standard length truck beds may accommodate lengths of up to 8 feet with the lift gate closed. Short-box truck beds may accommodate lengths of up to 6 feet with the lift gate closed. In some embodiments, the frame 104 may be designed to fit within a length of the truck bed with the lift gate closed. In this regard, a length of the outer perimeter of the frame 104 may be selected such that the frame 104 may be adapted to fit between an end wall (e.g., end wall adjacent to a cab) and the lift gate. For example, the length of the perimeter may be 8 feet, 6 feet, or less.

In some embodiments, the frame 104 may include one or more shock absorbers (not depicted). For example, the shock absorbers may be mounted to a bottom surface of one or more of the leg members 130 or the lower-cross members 132. The frame 104 may then rest on the shock absorbers to reduce a contact between the frame 104 and the truck bed. By reducing the contact between the frame 104 and the truck bed a wear on both the frame 104 and the truck bed may similarly be reduced. The shock absorbers may include any kind of shock absorber, such as, but not limited to, rubber bumpers or vibration damping pads.

In some embodiments, the frame 104 may include one or more components for improving a strength or rigidity of the frame 104. For example, the frame 104 may include one or more gussets 134. The gussets 134 may be coupled between the leg members 130 and one or more of the upper-cross members 128 or the lower-cross members 132. The gussets 134 are not intended to be limiting. In this regard, a variety of bracing or other structural members may improve a strength or a rigidity of the frame 104.

In some embodiments, the upper-cross members 128 may extend beyond the outer perimeter defined by the leg members 130 and the lower-cross members 132. In this regard, the upper-cross members 128 may extend beyond the outer perimeter by a length. The upper-cross members 128 may thus be configured to couple (e.g., fixedly attach; detachably attach) with the support legs 106. One or more of the gussets 134 may further be disposed between the upper-cross member 128 and the leg member 130, in an external facing manner. This may be beneficial in improving a strength of the upper-cross member 128, when the hopper 102 and the frame 104 are being raised by a connection with the upper-cross member (e.g., by the support legs 106 and the jacks 108).

The bulk material tender 100 may also include the support legs 106. The support legs 106 may include an upper portion by which the support legs 106 may be configured to couple with the frame 104. For example, the support legs 106 may be coupled to the upper-cross members 128 of the frame 104. The upper portion of the support leg 106 may include tubing with an appropriately sized width for receiving or being received by the upper-cross member 128. The support legs 106 may also include a vertical portion. The upper portion and the vertical portion of the support leg 106 may be connected by one or more gussets for improving a strength of the support leg 106. The support legs 106 may include a foot portion. The support legs 106 may thus provide a connection between the frame and a lifting means (e.g., the jacks 108), by which the frame 104 and similarly the hopper 102 may be vertically raised and lowered between one or more positions.

In some embodiments, the support legs 106 may be arranged such that the support legs 106 extend beyond the perimeter of the frame 104 in a first direction. By extending beyond the perimeter of the frame 104 in the first direction, the support legs 106 may similarly fit over a side wall of a truck, when the bulk material tender 100 is supported by the truck bed. Although the support legs 106 are described as coupling with the upper-cross member 128 and similarly extending beyond the perimeter of the frame 104 in the first direction, this is not intended as a limitation on the present disclosure. In some embodiments, the support legs 106 are coupled to the lower-cross member 132 (not depicted). In some embodiments, the supports legs 106 may also be arranged to extend beyond the perimeter of the frame 104 in a second direction. By extending beyond the perimeter of the frame in the second direction, the support legs 106 may be mounted over a rear end of the truck bed (e.g., over a bumper) when the bulk material tender 100 is supported by the truck bed.

The bulk material tender 100 may include the jacks 108. The jacks 108 may be coupled to the foot portion of the support legs 106. The jacks 108 may be vertically adjustable by which the jacks 108 are configured to raise and lower the support legs 106, and similarly the frame 104 and the hopper 102. The jacks 108 may include any suitable jack for raising and lowering the support legs 106, the frame 104, and the hopper 102, such as, but not limited to, a screw jack (e.g., electrical or mechanical), a railroad jack (e.g., including a rack and pinion), or a hydraulic jack (e.g., including one or more of a manual pump connected by hose to a ram, a foot pump, a hand pump, a bottle jack, an air hydraulic jack, etc.). Thus, the jacks 108 may be configured to raise and lower the support legs 106, the frame 104, and the hopper 102. In this regard, the jacks 108 may be configured to lower the frame 104 onto a truck bed. Similarly, the jacks 108 may be configured to raise the frame 104 from the support bed. This may be advantageous in allowing the bulk material tender 100 to be self-loading and self-unloading.

In some embodiments, one or more components of the bulk material tender 100 are configured to detachably attach from the frame 104. The ability to detach components of the bulk material tender 100 may provide for a reduced width of the bulk material tender 100. For example, the one or more support legs 106 may be configured to detachably attach to the upper-cross members 128 of the frame 104. The one or more support legs 106 may be detachably attached to the frame in any suitable manner, including, but not limited to, a bolt, clevis pin, a quick-release pin, a locking pin, a cotter pin, a strap, or other form of fastener. Detaching the support legs 106 from the frame 104 may reduce a width of the bulk material tender 100. In this regard, the bulk material tender 100 may be hauled by the truck bed over local, state, and federal roadways without special permitting. Upon detachment, the support legs 106 may be stored alongside the frame 104 or may be stored apart from the frame 104. By way of another example, the one or more jacks 108 may be configured to detachably attach from the one or more support legs 106. In some embodiments, the jacks 108 are detachably attached to the foot portion of the support legs 106. In some embodiments, the jacks 108 are fixed to the foot portion of the support legs 106. In some embodiments, the support legs 106 are fixed to the associated frame member. In some embodiments, the support legs are detachably attached to the associated frame member. As may be understood, there may be a variety of permutations of detachable or fixed permutations regarding the jacks 108, support leg 106, and frame members. However, the ability to detach the jacks 108 from the frame 104 (i.e., by detachably attaching from the jacks 108 from the support legs 106, by detachably attaching the support legs 106 from the frame member) may be advantageous in reducing a likelihood the jacks 108 run into a ground surface or other object while the bulk material tender 100 is driven between sites. Furthermore, the ability to detach the support legs 106 from the frame member may be advantageous in reducing a width of the bulk material tender 100 while driving between sites.

The bulk material tender 100 may include a slide gate valve 110 (also referred to as a knife gate, or similar). The slide gate valve 110 may be connected to the hopper 102. For example, the slide gate valve 110 may be connected to the bottom opening 114 of the hopper 102. The slide gate valve 110 may include a flat plate. The flat plate may be configured to slide between a closed position and one or more open positions. By sliding between the closed position and the one or more open positions, material stored within the hopper 102 may be selectively output from the bottom opening 114 by way of the slide gate valve 110. The material may then be received by one or more other components of the bulk material tender 100, such as the rotary airlock 122. The slide gate valve 110 may thus reduce forces corresponding to the bulk material on one or more components of the bulk material tender 100, such as an airlock or an auger. Furthermore, the slide gate valve 110 may serve as an air seal, preventing negative or positive pressure from the pneumatic conveyor 120 from being lost to the hopper 102. In this regard, an efficiency of the pneumatic conveyor 120 may be improved.

In some embodiments, the slide gate valve 110 is manually configured between positions by a user physically pushing or pulling the slide gate valve 110 to the desired position. In some embodiments, the slide gate valve 110 is operable between positions in response to a signal. For example, the signal may be received from a push button or other user input device. By way of another example, the signal may be received from a controller (e.g., in a feedback loop for selectively controlling the output). Thus, the slide gate valve 110 may include any suitable slide gate valve, including, but not limited to, a pneumatic-actuated, electrically-actuated, or hand-actuated slide gate valve.

The bulk material tender 100 may include the rotary airlock 122. The rotary airlock 122 may be coupled to the slide gate valve 110. Thus, the rotary airlock 122 may be configured to receive material from the hopper 102 by way of the slide gate valve 110. The material received may then pass through the rotary airlock 122 (e.g., for conveyance by the pneumatic conveyor 120). The rotary airlock 122 may further be configured to create a pressure differential between the hopper 102 and the pneumatic conveyor 120. In this regard, as the pneumatic conveyor creates pressure (e.g., positive pressure or negative pressure), the material within the hopper 102 may remain at or substantially near the surrounding air pressure. By remaining near the surrounding air pressure, the material within the hopper 102 may be prevented from being suck or blown out of the hopper 102 by backpressure. The rotary airlock 122 may thus provide material from the hopper to the pneumatic conveyor 120 without a significant loss in pressure differential. In some embodiments, the rotary airlock is shaft driven (e.g., by an electric motor). For example, the rotary airlock may be shaft driven in response to a signal from a controller.

The bulk material tender 100 may include the pneumatic conveyor 120. The bulk material tender 100 may include a pneumatic conveyor 120. The pneumatic conveyor 120 may be configured to receive the material from the hopper 102. For example, the pneumatic conveyor 120 may receive the material from the hopper 102 by way of the slide gate valve 110 and the rotary airlock 122. The bulk material tender 100 may further be configured to convey the material to a desired location. For example, the pneumatic conveyor 120 may generate a pressure (e.g., a positive pressure; a negative pressure) for conveying the material. The material may then be conveyed to the desired location by a hose of the pneumatic conveyor. Thus, the pneumatic conveyor 120 may include any suitable device for pneumatically conveying the material, such as, but not limited to, a negative pressure (suction/vacuum) system, a positive pressure system (blower), or some combination of a negative pressure and positive pressure system.

The pneumatic conveyor 120 includes a hose. The hose may provide for directional control of the material to be conveyed. For example, a user may move the hose into a planter or other such device. The pneumatic conveyor 120 may then receive material from the hopper 102, generate the pressure, and convey the material by way of the hose to the planter. In some embodiments, the hose may be held by the hose holders 126. The hose holders 126 may be attached to one or more of the frame 104 or the hopper 102. The hose holder 126 may hold the material hose to improve ease-of-transport and may provide stability for the hose when the bulk material tender 100 is conveying material from the hopper 102.

In some embodiments, the pneumatic conveyor 120 includes a valve. The valve may control the direction by which material is conveyed. By the valve the pneumatic conveyor 120 may be selectively configured to both convey material from the hopper 102 and convey material to the hopper 102. For example, the hopper 102 may include an access post (not depicted). The access post may be coupled to the pneumatic conveyor 120 by a secondary fill hose. The secondary fill hose may normally not be under pressure. Upon actuation of the valve, the secondary fill hose may receive pressure for conveying material (e.g., material from a seed bag or similar) to the hopper 102. By the ability to suction material and convey the material to the hopper 102, the pneumatic conveyor 120 may thus be used to fill the hopper 102. This may be advantageous in reducing the need to manually fill the hopper 102 (e.g., with seed bags) and/or to fill the hopper 102 by raising a seed box above the hopper (e.g., by way of forklift). Although the pneumatic conveyor 120 is described as including the valve, this is not intended as a limitation on the present disclosure. In this regard, the pneumatic conveyor 120 may be functional as a one-way conveyor without the ability to fill the hopper 102.

The bulk material tender 100 may include the power unit 124. The power unit 124 may be configured to provide power to one or more components of the bulk material tender 100. For example, the power unit 124 may comprise a generator including a combustion engine (e.g., natural gas, diesel, gasoline, etc.) which rotates an alternator to generate an electric current. By way of another example, the power unit 124 may include one or more batteries, with such batteries being powered by an onboard generator, to the truck main voltage, or to a utility power. Such power unit 124 may provide power to various components of the bulk material tender 100, including, but not limited to, an electric motor-controlled blower, a pneumatic conveyor, an auger, one or more jacks, one or more sensors, or a controller. By way of another example, the power unit 124 may include a plug or electrical connector by which the bulk material tender 100 may receive electrical power from the associated truck. In this regard, the plug may receive electrical power provided from the battery of the truck, an alternator charging system of the truck, or a generator carried by the truck.

In some embodiments, the bulk material tender 100 includes a slide assembly 136. The slide assembly 136 may be connected to the frame 104. The slide assembly 136 may also be connected to one or more of the power unit 124 or the pneumatic conveyor 120. The slide assembly 136 may be configured to transition the power unit 124 or the pneumatic conveyor 120 relative to the frame 104. For example, such components may be transitioned between a stowed position and a deployed position. In this regard, the components may at least partially fit within the outer perimeter of the frame 104 in the stowed position. By fitting the power unit and/or the pneumatic conveyor 120 within the outer perimeter, the bulk material tender 100 may include a reduced length. The reduced length may be advantageous for transport. For example, the bulk material tender 100 may be configured for transport in a truck bed with a liftgate of the truck raised without interfering with the bulk material tender 100. Furthermore, the deployed position may provide for additional room within the frame 104 when operating the pneumatic conveyor 120. In this regard, the power unit 124 and/or the pneumatic conveyor 120 may be at least partially disposed outside of the perimeter in the deployed position. The slide assembly 136 may thus allow for the bulk material tender 100 to become compact with the tail gate up and non-compact for operation, starting, serviceability, or for access underneath the hopper 102. The slide assembly 136 may include any suitable slide assembly, including, but not limited to, a slide (e.g., stacked slides, locking slides, partial-extension slides, hold-open slides, base mount slides, side mount slides, hold-closed slides, etc.), one or more rollers, a carriage and guide rail (e.g., ball bearing carriage, sleeve bearing carriage, track roller carriage, roller bearing carriage, etc.) an actuator (e.g., electric, pneumatic, etc.), or a lead screw and nut. The slide assembly 136 may further include a drawer onto which the power unit 124 and/or the pneumatic conveyor 120 are mounted. In some embodiments, the slide assembly 136 includes a handle by which a user may pull or push the slide assembly 136 for transitioning the pneumatic conveyor 120 or the power unit 124 relative to the frame 104. The handle may to provide ease of access while transitioning between the stowed position and the deployed position. Such handle may be formed of the same material as the slide assembly (e.g., during a manufacturing process), or may be separately attached.

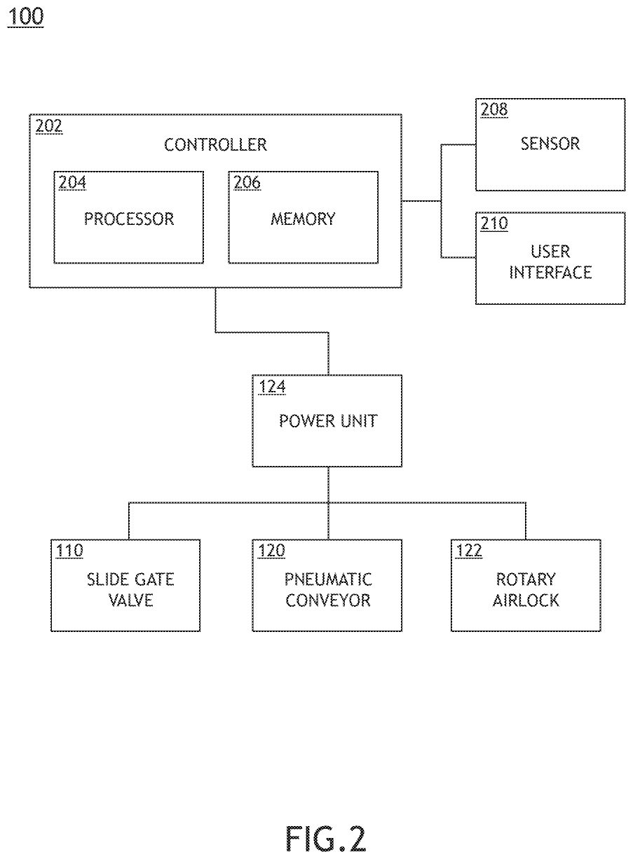

Referring now to FIG. 2, a simplified control diagram for the bulk material tender 100 is described, in accordance with one or more embodiments of the present disclosure.

In some embodiments, the bulk material tender 100 includes a controller 202. The controller 202 may include one or more processor 204 and one or more memory 206. The processors 204 may be configured to execute program instructions maintained on the memory 206. In this regard, the one or more processor 204 of the controller 202 may execute any of the various process steps described throughout the present disclosure, such as, but not limited to, selectively controlling one or more of the slide gate valve 110, the rotary airlock 122, or the pneumatic conveyor 120. In some embodiments, the controller 202 is configured to selectively control one or more components of the bulk material tender 100. For example, the controller 202 may selectively control one or more of the slide gate valve 110, the pneumatic conveyor 120, or the rotary airlock by selectively controlling a power supplied from the power unit 124 to the associated component. In some embodiments, the controller 202 is configured to selectively control the components by a control loop. In the case of a control algorithm, one or more program instructions or methods may be configured to operate via proportional control, feedback control, feedforward control, integral control, proportional-derivative (PD) control, proportional-integral (PI) control, proportional-integral-derivative (PID) control, or the like.

In some embodiments, the bulk material tender 100 includes one or more sensors 208. The sensors 208 may be configured to read various data, including, but not limited to, material weight in the hopper 102 or pneumatic pressure of the pneumatic conveyor 120. For example, the sensor 208 may include a load cell configured to weight the material in the hopper. The load cell may then provide the hopper weight data to the controller 202. The controller 202 may then utilize the hopper weight data to meter the amount of seed output at any given time (e.g., by selectively controlling the slide gate valve 110, the rotary airlock, or the pneumatic conveyor 120). By way of another example, the sensor 208 may include a pressure transducer for measuring a pressure within the pneumatic conveyor 120.

In some embodiments, a user interface 210 is communicatively coupled to the controller 202. In one embodiment, the user interface 210 may include, but is not limited to, one or more desktops, laptops, tablets, and the like. In another embodiment, the user interface 210 includes a display used to display images representative of the data of the bulk material tender 100 to a user. For example, the display may indicate a weight of material in the hopper 102 as sensed by the load cell. The display of the user interface 210 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 210 is suitable for implementation in the present disclosure. In another embodiment, a user may input selections and/or instructions responsive to data displayed to the user via a user input device of the user interface 210. For example, the user interface 210 may receive a selection of an amount of material to be dispensed or a feed rate of the material to be dispensed.

For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory).

Furthermore, the memory may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a solid-state drive and the like. It is further noted that memory medium may be housed in a common controller housing with the one or more processors. In one embodiment, the memory medium may be located remotely with respect to the physical location of the one or more processors.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory. It is further contemplated that each of the embodiments of the method described above may include any other step(s) of any other method(s) described herein. In addition, each of the embodiments of the method described above may be performed by any of the systems described herein.

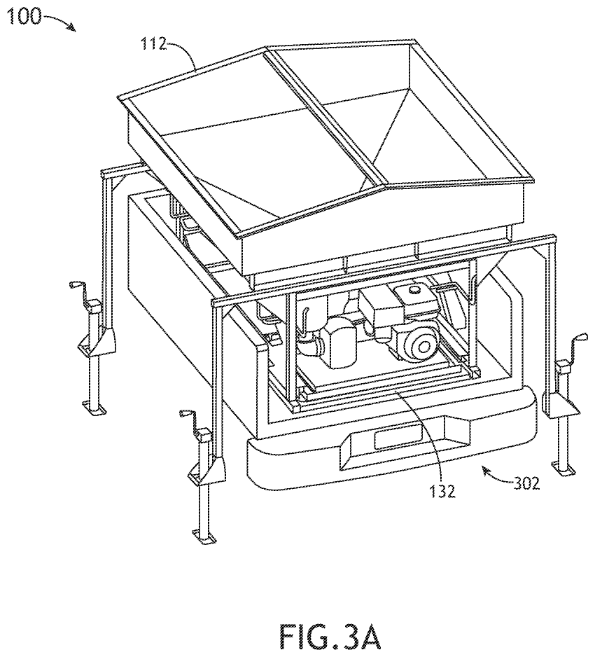

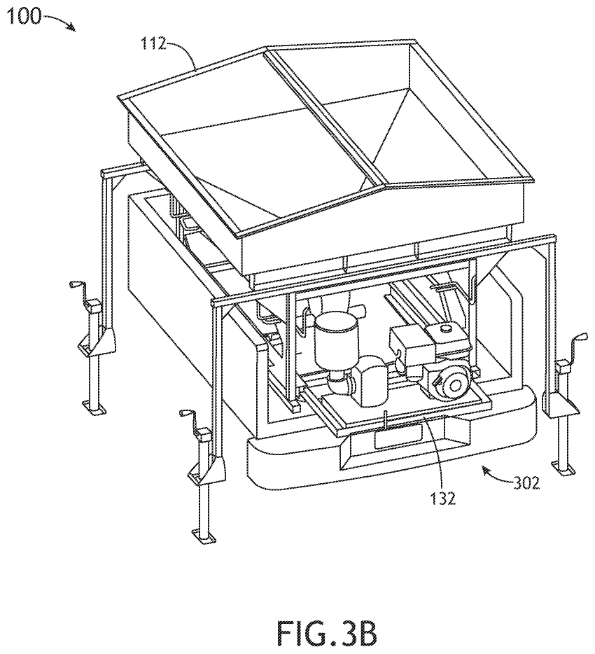

Referring now to FIGS. 3A-3B, the material tending system 300 is described, in accordance with one or more embodiments of the present disclosure. The material tending system 300 may include the bulk material tender 100. The material tending system 300 may also include a pickup truck 302. The pickup truck 302 may include any pickup truck known in the art. As depicted, the frame of the bulk material tender 100 may fit within the bed of the pickup truck 302 (e.g., between the side wall or wheel well). Furthermore, the power unit 124 and the pneumatic conveyor 120 may be in the deployed position, such that the power unit 124 and the pneumatic conveyor 120 extend above the lift gate of the pickup truck 302, where the liftgate is lowered.

In embodiments, the bulk material tender 100 may be self-loaded onto the pickup truck 302 by the jacks 108. In this regard, the bulk material tender 100 may be loaded onto a truck bed by engaging the jacks 108 to raise the frame 104 above a height of the bed. The truck may then be driven below the frame 104. The frame 104 may then be lowered onto the bed by the jacks. Subsequent to being loaded, a seed box may be loaded onto and secured by the bulk material tender 100, with the hopper 102 being filled with the seed. The bulk material tender 100 may now be hauled by the truck bed to a location. Once at the destination, the material may be selectively dispensed by the pneumatic conveyor 120. In further embodiments, the bulk material tender 100 may be self-unloaded from the pickup truck 302 by the jacks 108. In this regard, the bulk material tender 100 may be driven to a desired storage spot by the pickup truck 302. The jacks 108 may then be engaged to lift the frame 104 from the bed. The pickup truck 302 may then be driven out from underneath the frame 104. The jacks 108 may then be locked in place by one or more pins, to prevent the bulk material tender 100 from moving. The bulk material tender 100 may remain supported by the one or more support legs 106 and the one or more jacks 108 until such time as the bulk material tender 100 is reloaded onto the bed of the pickup truck. Thus, the jacks 108 may provide the bulk material tender 100 a means for self-loading and self-unloading from the bed.

In some embodiments, the bulk material tender 100 may be secured to the pickup truck 302 by one or more of blocking, bracing, dunnage, strapping, or lashing. For example, the frame 104 may include one or more points to receive a tie down or ratchet strap.

In some embodiments the pickup truck 302 may include sufficient electrical power to run components (e.g., slide gate valve 110, rotary airlock 122, pneumatic conveyor 120) of the bulk material tender 100. For example, the pickup truck 302 may be an electric vehicle or include an truck mounted generator. In this example, the power unit 124 of the bulk material tender 100 may be an electrical connector, by which the bulk material tender 100 may receive electrical power from the pickup truck 302. Such electrical connector may include any electrical connector known in the art.

Referring generally again to FIGS. 1A-3.

One or more components of the bulk material tender 100, such as, but not limited to, the frame 104 or the support legs may comprise tubing (mechanical or structural) or angle iron. Such tubing may comprise any suitable tubing, including, but not limited to, square tubing, rectangular tubing, circular tubing, or custom tubing. Such angle iron may comprise any suitable angle iron, including, but not limited to, 90-degree angle, I-bar, T-bar, or U-channels. Furthermore, such components may comprise one or more suitable materials known in the art, such as, but not limited to aluminum or steel. It is envisioned that in embodiments where one or more of the components is a steel material, said component may be cold-forged, hot-forged, heat treating (e.g. annealing, quenching, tempering, etc.), surface treated, or treated with any other process to selectively adjust the material properties of the component, thereby improving strength and corrosion resistance.

Although the material held and conveyed by the bulk material tender 100 has been described as being seeds, this is not intended to be a limitation on the present disclosure. For example, the bulk material tender 100 may be used with a variety of bulk material, such as, but not limited to, seed (e.g., bagged hybrid seed corn, etc.), cattle feed (e.g., for filling multiple feed pans to reduce competition for feed), fertilizer, sand, or salt (e.g., dispensing material into a push spreader). In this regard, the hopper design and material actuator may be selected based upon the material to be conveyed, while retaining beneficial properties of the bulk material tender 100.

Although the bulk material tender 100 has been described as being attached to the pickup truck 302, this is not intended to be a limitation on the present disclosure. For example, the bulk material tender 100 may be attached to a variety of wheeled devices, such as, but not limited to, pull-behind trailers, and flat-bed trucks.

Although the bulk material tender 100 has been described as being self-loading and self-unloading onto a truck by the jacks 108, this is not intended as a limitation on the present disclosure. In some embodiments, the frame 104 includes one or more portions configured to receive a forklift fork, by which the bulk material tender 100 may be loaded and unloaded onto the truck.

Although the bulk material tender 100 has been described as including the pneumatic conveyor 120 for conveying material from the hopper 102 to a desired location, this is not intended as a limitation on the present disclosure. For example, an auger may be used to convey material from the hopper 102. The auger may include a screw with one or more rotating helical blades, such helical blades being configured to convey material held by the hopper. The screw may be housed within a trough, to contain the material. The screw may be connected to a motor to rotate the screw. The motor may have a variable rate controlled by one or more process controllers to vary the rotation rate of the screw. A variable rotation rate of the screw may correspond to a variable rate of material flow. The motor may be powered by the power unit, in accordance with one or more embodiments of the present disclosure. The material may be conveyed by the auger to one or more material handling chutes (not depicted).

The various dimensions and configuration of features provided herein is not intended to be limiting. In this regard, the bulk material tender 100 may include various suitable designs for improving safety factors, cost, or weight.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A bulk material tender comprising:
a hopper including at least one side wall, the at least one side wall defining a top opening of the hopper by which the hopper is configured to receive material, the at least one side wall of the hopper further defining a bottom opening of the hopper, the bottom opening configured to receive the material from the hopper by a gravity feed;
a frame connected to the hopper, the frame configured to support the hopper by the connection between the frame and the hopper, the frame including an outer perimeter with a width of less than forty-eight inches by which the frame is adapted to fit between wheel wells of a pickup truck;
a rotary airlock configured to receive the material from the hopper;
a pneumatic conveyor coupled to the rotary airlock, the pneumatic conveyor including a hose, the pneumatic conveyor configured to generate a pressure to convey the material by way of the hose; and
a power unit configured to supply power to at least the pneumatic conveyor, wherein the pneumatic conveyor is configured to generate the pressure in response to the power supplied from the power unit.

2. The bulk material tender of claim 1, further comprising a sliding rail coupled to the frame, wherein the sliding rail is configured to translate the pneumatic conveyor relative to the frame; the pneumatic conveyor translated between a stowed position and a deployed position.

3. The bulk material tender of claim 2, wherein the sliding rail is further configured to translate the power unit relative to the frame.

4. The bulk material tender of claim 1, further comprising a plurality of support legs and a plurality of jacks; the plurality of support legs coupled to the frame; the plurality of jacks coupled to the plurality of support legs; wherein the plurality of jacks are vertically adjustable by which the jacks are configured to translate the plurality of support legs, the frame, and the hopper; the frame translatable between a lowered position and a raised position.

5. The bulk material tender of claim 4, wherein the plurality of support legs are coupled to the frame by a detachable attachment.

6. The bulk material tender of claim 5, the frame including a plurality of upper-cross members, a plurality of leg members, and a plurality of lower-cross members; wherein the plurality of support legs are detachably attached to the plurality of upper-cross members.

7. The bulk material tender of claim 4, wherein the plurality of jacks comprise at least one of a screw jack or a hydraulic jack.

8. The bulk material tender of claim 1, wherein the pneumatic conveyor is an electric motor controlled blower.

9. The bulk material tender of claim 1, further comprising a slide gate valve disposed between the rotary airlock and the bottom opening of the hopper.

10. The bulk material tender of claim 9, further comprising a controller, wherein the controller is configured to selectively control at least one of the slide gate valve, the pneumatic conveyor, or the rotary airlock.

11. The bulk material tender of claim 10, wherein the controller is configured to receive a signal of a user input and control at least one of the slide gate valve, the pneumatic conveyor, or the rotary airlock in response to the user input.

12. The bulk material tender of claim 10, further comprising a load cell configured to measure a weight of the material in the hopper, wherein the controller is configured to selectively control at least one of the slide gate valve, the pneumatic conveyor, or the rotary airlock based on the weight measured by the load cell.

13. The bulk material tender of claim 1, further comprising a load cell and a display; wherein the load cell is configured to measure a weight of the material in the hopper; wherein the display is configured to generate an image representative of the weight measured by the load cell.

14. A bulk material tender comprising:
a hopper including at least one side wall, the at least one side wall defining a top opening of the hopper by which the hopper is configured to receive material, the at least one side wall of the hopper further defining a bottom opening of the hopper, the bottom opening configured to receive the material from the hopper by a gravity feed;
a frame connected to the hopper, the frame configured to support the hopper by the connection between the frame and the hopper, the frame including a plurality of upper-cross members, a plurality of leg members, and a plurality of lower-cross members, the frame including an outer perimeter defined by the plurality of leg members and the plurality of lower-cross members; the outer perimeter including a width of less than forty-eight inches;
a plurality of support legs detachably attached to the plurality of upper-cross members of the frame;
a plurality of plurality of jacks coupled to the plurality of support legs; wherein the plurality of jacks are vertically adjustable by which the jacks are configured to translate the plurality of support legs, the frame, and the hopper;
a slide gate valve coupled to the bottom opening of the hopper;
a rotary airlock coupled to the slide gate valve by which the rotary airlock is configured to receive the material from the hopper;
a pneumatic conveyor coupled to the rotary airlock, the pneumatic conveyor including a hose, the pneumatic conveyor configured to generate a pressure to convey the material by way of the hose; and
a power unit configured to supply power to at least the pneumatic conveyor, wherein the pneumatic conveyor is configured to generate the pressure in response to the power supplied from the power unit.

15. A material tending system comprising
a vehicle;
a bulk material tender configured to fit within a stowage area of the vehicle, the bulk material tender comprising:
a hopper including at least one side wall, the at least one side wall defining a top opening of the hopper by which the hopper is configured to receive material, the at least one side wall of the hopper further defining a bottom opening of the hopper, the bottom opening configured to receive the material from the hopper by a gravity feed;
a frame connected to the hopper, the frame configured to support the hopper by the connection between the frame and the hopper, the frame including an outer perimeter with a width of less than forty-eight inches by which the frame is adapted to fit between wheel wells of the pickup truck;
a rotary airlock configured to receive the material from the hopper;
a pneumatic conveyor coupled to the rotary airlock, the pneumatic conveyor including a hose, the pneumatic conveyor configured to generate a pressure to convey the material by way of the hose; and
a power unit configured to supply power to at least the pneumatic conveyor, wherein the pneumatic conveyor is configured to generate the pressure in response to the power supplied from the power unit.

16. The material tending system of claim 15, the bulk material tender further comprising a sliding rail, wherein the sliding rail is configured to translate the pneumatic conveyor relative to the frame between a stowed position and a deployed position.

17. The material tending system of claim 16, the pickup truck further comprising a tail gate; wherein the tail gate is configured to be raised when the pneumatic conveyor is in the stowed position.

18. The material tending system of claim 15, the bulk material tender further comprising a plurality of support legs and a plurality of jacks; the plurality of support legs coupled to the frame; the plurality of jacks coupled to the plurality of support legs; wherein the plurality of jacks are vertically adjustable by which the jacks are configured to translate the plurality of support legs, the frame, and the hopper.

19. The material tending system of claim 18, wherein the frame is translatable between a lowered position in which the frame is supported by the pickup truck and a raised position in which the frame is supported by the plurality of support legs and the plurality of jacks.

20. The material tending system of claim 18, wherein the plurality of support legs are coupled to the frame by a detachable attachment.
